(19) United States
(12) Patent Application Publication
(10) Pub. No.: US 2025/0321667 A1
(43) Pub. Date: Oct. 16, 2025

(54) CONTENT DISPLAY METHOD, COMPUTER-READABLE STORAGE MEDIUM, AND ELECTRONIC DEVICE

(71) Applicant: Beijing Youzhuju Network Technology Co., Ltd., Beijing (CN)

(72) Inventors: Zhigang JI, Beijing (CN); Xiaowei LI, Beijing (CN); Chenglong LI, Beijing (CN); Yang YU, Beijing (CN)

(21) Appl. No.: 19/179,995

(22) Filed: Apr. 15, 2025

(30) Foreign Application Priority Data
Apr. 16, 2024 (CN) 202410460507.9

(51) Int. Cl. G06F 3/0484

(52) U.S. Cl. CPC G06F 3/0484

(57) ABSTRACT

The present disclosure provides a content display method, an apparatus, a computer-readable storage medium, an electronic device, and a program product. The content display method includes: displaying a first content display page in response to a trigger operation for target content, where the first content display page is configured to display the target content, and the target content includes a first number of discontinuous pieces of first content; displaying a first interactive control on the first content display page, and sequentially displaying a second number of pieces of second content in response to a trigger operation for the first interactive control, where the second number is less than or equal to the first number; and after all of the second number of pieces of second content are displayed, displaying, on the first content display page, target content that does not include the first number of pieces of first content.

### CROSS-REFERENCE TO RELATED APPLICATION

The present application claims the priority to Chinese Patent Application No. 202410460507.9, filed on Apr. 16, 2024, the entire disclosure of which is incorporated herein by reference as portion of the present application.

### TECHNICAL FIELD

Embodiments of the present disclosure relate to a content display method, an apparatus, a computer-readable storage medium, an electronic device, and a program product.

### BACKGROUND

With the development of Internet and multimedia technology, more and more users browse multimedia resources such as videos and pictures over the Internet.

In the related art, taking a video playing scenario as an example, during the playing process of a target video, a plurality of patch videos may be inserted, which may interrupt the user's viewing of the target video for many times, reducing the playing smoothness of the target video and resulting in a poor user experience.

### SUMMARY

The Summary is provided to introduce concepts in a simplified form that are described in detail in the following Detailed Description. The Summary is not intended to identify key features or essential features of the claimed technical solutions, nor is it intended to be used to limit the scope of the claimed technical solutions.

The present disclosure provides a content display method, including:
displaying a first content display page in response to a trigger operation for target content, where the first content display page is configured to display the target content, and the target content includes a first number of discontinuous pieces of first content;
displaying a first interactive control on the first content display page, and sequentially displaying a second number of pieces of second content in response to a trigger operation for the first interactive control, where the second number is less than or equal to the first number, and the first content and the second content are the same type of content; and
after all of the second number of pieces of second content are displayed, displaying, on the first content display page, target content that does not include the first number of pieces of first content.

The present disclosure further provides a content display apparatus, including:
a first display module, configured to display a first content display page in response to a trigger operation for target content, where the first content display page is configured to display the target content, and the target content includes a first number of discontinuous pieces of first content;
a second display module, configured to display a first interactive control on the first content display page, and to sequentially display a second number of pieces of second content in response to a trigger operation for the first interactive control, where the second number is less than or equal to the first number, and the first content and the second content are the same type of content; and
a third display module, configured to, after all of the second number of pieces of second content are displayed, display, on the first content display page, target content that does not include the first number of first content.

The present disclosure further provides a computer-readable medium having a computer program stored thereon, where when the program is executed by a processing apparatus, the steps of the method according to any one of the above first aspect are implemented.

The present disclosure further provides an electronic device, including:
a storage apparatus having a computer program stored thereon; and
a processing apparatus, configured to execute the computer program in the storage apparatus, to implement the steps of the method according to any one of the above first aspect.

The present disclosure further provides a computer program product, including a computer program, where when the computer program is executed by a processor, the steps of the method according to any one of the above first aspect are implemented.

### BRIEF DESCRIPTION OF DRAWINGS

The above and other features, advantages and aspects of various embodiments of the present disclosure will become more apparent in combination with the drawings and with reference to the following detailed description. Throughout the drawings, the same or similar reference numerals denote the same or similar elements. It should be understood that the drawings are schematic and that components and elements are not necessarily drawn to scale. In the drawings:

FIG. 1 is a flowchart of a content display method according to an exemplary embodiment of the present disclosure;

FIG. 2 is a schematic diagram of a video playing page according to an exemplary embodiment of the present disclosure;

FIG. 3 is a schematic diagram of a display process of a second content display page according to an exemplary embodiment of the present disclosure;

FIG. 4 is a schematic diagram of a card according to an exemplary embodiment of the present disclosure;

FIG. 5 is a schematic diagram of another card according to an exemplary embodiment of the present disclosure;

FIG. 6 is a structural block diagram of a content display apparatus according to an exemplary embodiment of the present disclosure; and

FIG. 7 is a schematic structural diagram of an electronic device according to an exemplary embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are only for exemplary purposes and are not intended to limit the scope of protection of the present disclosure.

It should be understood that the various steps described in the method implementations of the present disclosure may be performed in different orders and/or in parallel. Furthermore, the method implementations may include additional steps and/or omit performing the illustrated steps. The scope of the present disclosure is not limited in this regard.

The term “include” and its variants as used herein are open-ended inclusions, i.e., “include but not limited to”. The term “based on” is “at least partially based on”. The term “an embodiment” means “at least one embodiment”; the term “another embodiment” means “at least one other embodiment”; and the term “some embodiments” means “at least some embodiments”. Relevant definitions of other terms will be given in the description below.

It should be noted that concepts such as “first” and “second” mentioned in the present disclosure are only used to distinguish between different apparatuses, modules, or units, and are not used to limit the order of functions performed by these apparatuses, modules, or units or their interdependence.

It should be noted that the modifications of “one” and “a plurality of” mentioned in the present disclosure are illustrative rather than restrictive, and those skilled in the art should understand that unless the context clearly indicates otherwise, they should be understood as “one or more”.

The names of messages or information exchanged between apparatuses in the implementations of the present disclosure are only for illustrative purposes, and are not intended to limit the scope of these messages or information.

It can be understood that before using the technical solutions disclosed in the embodiments of the present disclosure, the user should be informed of the type of personal information involved in the present disclosure, the scope of use, the use scenarios, etc., and the authorization of the user should be obtained in an appropriate manner in accordance with relevant laws and regulations.

For example, in response to receiving an active request from the user, prompt information is sent to the user to clearly prompt the user that the operation requested to be performed will require the acquisition and use of the user's personal information. Thus, the user can independently select whether to provide personal information to software or hardware such as an electronic device, an application program, a server, or a storage medium that performs the operations of the technical solutions of the present disclosure according to the prompt information.

As an optional but non-limiting implementation, the manner of sending prompt information to the user in response to receiving an active request from the user may be, for example, a pop-up window, and the prompt information may be presented in text in the pop-up window. In addition, the pop-up window may also carry a selection control for the user to choose whether to “agree” or “disagree” to provide personal information to the electronic device.

It can be understood that the above process of notifying and acquiring user authorization is only illustrative, and does not constitute a limitation to the implementations of the present disclosure, and other methods that meet relevant laws and regulations may also be applied to the implementations of the present disclosure.

In addition, it can be understood that the data involved in the technical solutions (including but not limited to the data itself, the acquisition or use of the data) should comply with the requirements of relevant laws and regulations.

In the related art, taking a video playing scenario as an example, during the playing process of a target video, a plurality of patch videos may be inserted, for example, the target video is a movie or TV drama video, and the patch video is a product introduction video. The plurality of patch videos are inserted into a plurality of different positions of the target video, respectively; for example, one patch video is inserted when the video is played for 10 minutes, and one patch video is inserted when the video is played for 20 minutes, and so on. In this way, the user's viewing of the target video may be interrupted many times, reducing the playing smoothness of the target video and resulting in a poor user experience.

In view of this, the present disclosure provides a content display method, an apparatus, a readable medium, an electronic device, and a program product to solve the above technical problems.

The embodiments of the present disclosure will be further explained below with reference to the drawings.

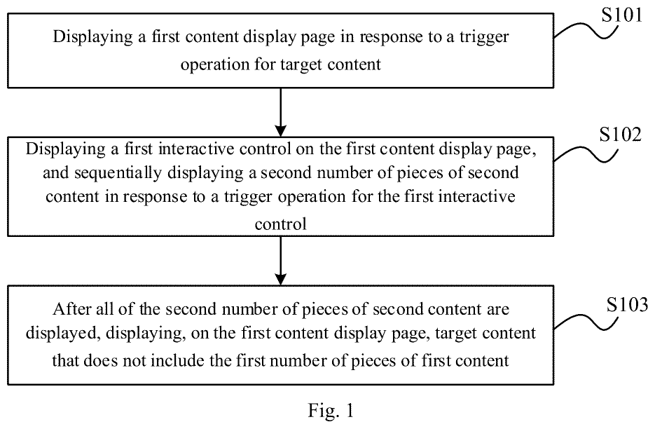

FIG. 1 is a flowchart of a content display method according to an exemplary embodiment of the present disclosure. Referring to FIG. 1, the method may include the following steps S101-S103.

S101: displaying a first content display page in response to a trigger operation for target content.

The first content display page is used to display the target content, and the target content includes a first number of discontinuous pieces of first content.

Exemplarily, the first content display page may be displayed through an application in a terminal device, or through a webpage in the terminal device. The terminal device may be a mobile terminal device, such as a mobile phone or a tablet, or may be a non-mobile terminal device, such as a desktop computer, etc., which is not limited in the embodiments of the present disclosure.

S102: displaying a first interactive control on the first content display page, and sequentially displaying a second number of pieces of second content in response to a trigger operation for the first interactive control.

The second number is less than or equal to the first number, and the first content and the second content are the same type of content.

Exemplarily, the second number and the first number may be set as required, for example, the second number is greater than or equal to half of the first number and less than or equal to the first number, which is not limited in the present disclosure.

S103: after all of the second number of pieces of second content are displayed, displaying, on the first content display page, target content that does not include the first number of pieces of first content.

Exemplarily, the target content may include specific content of the first number of pieces of first content, so that after all of the second number of pieces of second content are displayed, other content other than the first number of pieces of first content in the target content is displayed.

Alternatively, the target content may include a request interface for acquiring the first number of pieces of first content. For example, a product introduction video for product A is requested through a first interface when the video is played for 10 minutes, and a product introduction video for product B is requested through a second interface when the video is played for 20 minutes. In this way, after all of the second number of pieces of second content are displayed, no data interface is triggered to request a product introduction video during the video playing process. It can be specifically set as required, which is not limited in the present disclosure.

In a possible implementation, the target content, the first content, and the second content are all video content.

Exemplarily, for example, the target content is a movie or TV drama video, and the first content and the second content are both product introduction videos. Taking the case that the first number of pieces of first content are introduction videos for product A, product B, product C, product D, and product E as an example, during the playing process of the movie or TV drama video, for example, the introduction video for product A is played when the video is played for 10 minutes, and the introduction video for product B is played when the video is played for 20 minutes, and so on.

Exemplarily, the first number is the same as the second number, and the content of the first number of pieces of first content and the second number of pieces of second content may be all the same, partially the same, or completely different, so that the product introduction videos are intensively played before the movie or TV drama video is played, and no product introduction video is played during the playing process of the movie or TV drama video, thereby improving the user experience.

Exemplarily, the first number is different from the second number, and the second number of pieces of second content may be a part of the first number of pieces of first content. For example, the second number of pieces of second content are introduction videos for product A, product B, and product C, respectively. The second number of pieces of second content may also be other content different from the first number of pieces of first content. For example, the second number of pieces of second content are introduction videos for product F, product G, and product H, respectively. In this way, no product introduction video is played during the playing process of the movie or TV drama video either, and the fewer product introduction videos need to be viewed by the user before the movie or TV drama video is played than those that need to be viewed during the video playing process, which further improves the user experience.

In other possible implementations, the target content may also be audio, text, pictures, and other content, and the first content and the second content may be the same type as or different from the target content. For example, the target content is text content, and the first content and the second content are video content or picture content, or the target content is picture content, and the first content and the second content are also picture content, which can be specifically set according to actual application scenarios and requirements, and is not limited in the present disclosure.

Through the above technical solutions, before the target content is displayed, the second number of pieces of second content are sequentially displayed in response to the trigger operation for the first interactive control, and then during the display process of the target content, the target content including the first number of pieces of first content is not displayed. In this way, the display process of the target content can be prevented from being interrupted, the display smoothness of the target content can be improved, and the user experience can be improved. In addition, in the case where the second number is less than the first number, the total display duration of the second content is less than the total display duration of the first content, which can further improve the user experience.

In a possible implementation, the content display method further includes: displaying prompt information on the first content display page, where the prompt information is used to prompt that the first number of pieces of first content are not displayed during the display process of the target content by displaying the second number of pieces of second content.

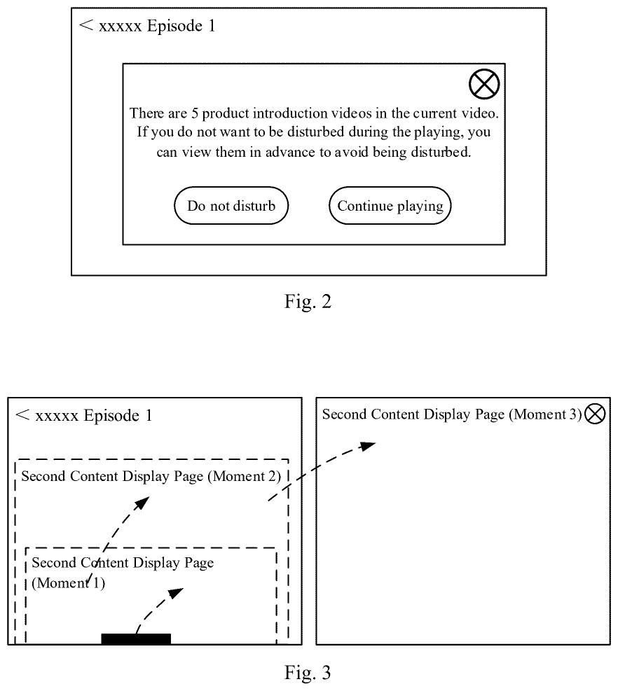

Exemplarily, taking the case that the target content is video content as an example, the first content display page is a video playing page. Referring to FIG. 2, a pop-up window can be displayed on the first content display page, and the first interactive control can be displayed in the pop-up window, such as the “Do not disturb” control in FIG. 2. The prompt information can be displayed in the pop-up window, and the specific content of the prompt information can be set according to requirements and actual situations. For example, in the case where the first number is the same as the second number, the prompt information such as “There are 5 product introduction videos in the current video. If you do not want to be disturbed during the playing, you can view them in advance to avoid being disturbed” is displayed. Alternatively, in the case where the first number is different from the second number, the prompt information as shown in FIG. 2 is displayed, and so on, which is not limited in the present disclosure.

Exemplarily, the first interactive control may also be directly displayed on the first content display page, and the prompt information may be displayed in or around the first interactive control. Alternatively, the prompt information may also be displayed when a mouse hovers over the first interactive control, and so on, which is not limited in the present disclosure.

By displaying the prompt information, it can be intuitively indicated that the display effect of the target content after the second content is displayed is different from the display effect of the target content without the second content.

In a possible implementation, the content display method further includes: displaying a third interactive control on the first content display page; and displaying, on the first content display page, target content that includes the first number of pieces of first content in response to a trigger operation for the third interactive control.

Exemplarily, continuing to refer to FIG. 2, a second interactive control can be displayed in the pop-up window, such as the “Continue playing” control shown in FIG. 2, or the closing control at the upper right corner of the pop-up window, which may be specifically set as required, and is not limited in the present disclosure. In this way, different playing manners are provided for the user to choose.

Exemplarily, continuing with the above example that the target content is the movie or TV drama video, and the first content is the product introduction video, in response to the trigger operation for the third interactive control, the pop-up window is closed, and the movie or TV drama video including the product introduction videos is continued to be played on the video playing page. For example, the introduction video for product A is played when the video is played for 10 minutes, and the introduction video for product B is played when the video is played for 20 minutes, and so on.

It should be noted that the second content may be displayed on the first content display page, or the second content may be displayed by jumping to a new page.

In a possible implementation, the sequentially displaying the second number of pieces of second content in response to the trigger operation for the first interactive control may include: displaying a second content display page in response to the trigger operation for the first interactive control, where the first content display page is different from the second content display page; and sequentially displaying the second number of pieces of second content on the second content display page.

Exemplarily, in response to the “Do not disturb” control as shown in FIG. 2, a new page can be jumped to, and the second number of pieces of second content can be sequentially displayed on the new page. Alternatively, in response to the “Do not disturb” control as shown in FIG. 2, the pop-up window can be closed, and the second number of pieces of second content can be sequentially displayed on the first content display page, which is not limited in the present disclosure.

In a possible implementation, the displaying the second content display page in response to the trigger operation for the first interactive control may include: displaying the second content display page from a preset position on the first content display page in response to the trigger operation for the first interactive control, according to a first preset dynamic effect. The content display method further includes: closing the second content display page and folding it to the preset position, according to a second preset dynamic effect, in response to a closing operation for the second content display page.

Exemplarily, in response to the “Do not disturb” control as shown in FIG. 2, the pop-up window is closed, and as shown in FIG. 3, the second content display page is gradually expanded from the bottom of the first content display page until the second content display page is fully displayed. In response to the closing operation for the second content display page, as the reverse process shown in FIG. 3, the second content display page is gradually folded from full display to the bottom of the page. In this way, the display and closing processes of the second content display page are dynamically displayed, thereby enriching the dynamic effect of page display. The preset position, the first preset dynamic effect, and the second preset dynamic effect may be set as required, which is not limited in the present disclosure.

It should be noted that the second content display page may be closed after all of the second content is displayed, or the second content display page may be closed during the process of displaying all of the second content, which is not limited in the present disclosure.

In a possible implementation, after all the second number of pieces of second content are displayed, the displaying, on the first content display page, target content that does not include the first number of pieces of first content may include: displaying a second interactive control after all of the second number of pieces of second content are displayed; and displaying, on the first content display page, the target content that does not include the first number of pieces of first content in response to a trigger operation for the second interactive control.

Exemplarily, the second interactive control is displayed after all of the second number of pieces of second content are displayed. In response to the second content being displayed on the first content display page, the target content that does not include the first number of pieces of first content continues to be directly displayed on the first content display page in response to the trigger operation for the second interactive control.

In response to the second content being displayed on the second content display page, the second content display page is closed and returns to the first content page in response to the trigger operation for the second interactive control, and the target content that does not include the first number of pieces of first content is displayed on the first content display page.

Exemplarily, in addition to displaying the second interactive control, prompt information may also be displayed to prompt the user that all of the second number of pieces of second content have been displayed, which is not limited in the present disclosure. A light prompt may also be displayed on the first content display page before displaying the target content that does not include the first number of pieces of first content, to prompt the user that the first number of pieces of first content will not be displayed during the display process of the target content, and then the light prompt disappears, and the target content that does not include the first number of pieces of first content is displayed on the first content display page, which is not limited in the present disclosure.

By displaying the second interactive control, the user can be prompted that the display of the second content ends, so as to avoid the user from interrupting the display of the second content in advance, resulting in the display of the first content during the subsequent display process of the target content, and the probability of playing all of the second content is also increased. Of course, prompt information for prompting a remaining display duration or a remaining display number of the second content may also be displayed when the second content is displayed, which may be specifically set as required, and is not limited in the present disclosure.

In addition to playing the target content by triggering the second interactive control, the target content that does not include the first number of pieces of first content may also be automatically displayed on the first content display page after all of the second number of pieces of second content are displayed, which may be specifically set as required, and is not limited in the present disclosure.

In a possible implementation, the content display method further includes: before all of the second number of pieces of second content are displayed, redisplaying the first interactive control on the first content display page in response to an interruption display operation for the second number of pieces of second content.

Exemplarily, in response to that the display of the second content is interrupted before all of the second content is displayed, the first interactive control can be redisplayed on the first content display page, for example, the pop-up window shown in FIG. 2 is redisplayed, so that the user can trigger the first interactive control on the first content display page again to display the second number of pieces of second content.

Of course, in response to the interruption display operation for the second number of pieces of second content, a pop-up window is displayed to prompt the user that the interruption of the display may result in the display of the first number of pieces of first content when the target content is displayed. The pop-up window may include a confirm control and a cancel control. In response to the confirm control being triggered, the first interactive control is redisplayed on the first content display page; and in response to the cancel control being triggered, the second number of pieces of second content continues to be displayed. It may be specifically set as required, which is not limited in the present disclosure.

In a possible implementation, the sequentially displaying the second number of pieces of second content in response to the trigger operation for the first interactive control may include: displaying a third number of cards in response to the trigger operation for the first interactive control, where each card corresponds to one piece of second content, and the third number is greater than the second number; and sequentially displaying the second number of pieces of second content corresponding to the second number of cards in response to a selection operation for the second number of cards among the third number of cards.

Exemplarily, cards corresponding to more than the second number of pieces of second content may be displayed for the user to choose. Continuing to take the case that the target content is the movie or TV drama video, and the first content and the second content are the product introduction videos as an example, for example, the third number of cards correspond to 5 product introduction videos, and in response to the trigger operation for the first interactive control, cards corresponding to the 5 product introduction videos may be displayed for the user to choose. For example, in the case where 3 product introduction videos need to be selected for playing, in response to the selection of the 3 cards, the 3 product introduction videos corresponding to the 3 cards may be automatically played sequentially, or in response to the confirmation operation after the selection of the 3 cards, the 3 product introduction videos corresponding to the 3 cards may be played sequentially, which may be specifically set as required, and is not limited in the present disclosure.

The product introduction videos corresponding to the third number of cards may be selected from the product introduction videos corresponding to the first number of pieces of first content, or new product introduction videos may be acquired, or the product introduction videos corresponding to the third number of cards may be composed of some product introduction videos corresponding to the first number of pieces of first content and some new product introduction videos, which may be specifically set as required, and is not limited in the present disclosure.

Exemplarily, the product introduction videos corresponding to the cards may also be played in sequence according to the order in which the user selects the cards, which may be specifically set as required and is not limited in the present disclosure.

In this way, it is convenient for the user to choose a piece of content he/she is interested in to display, the user experience is improved, and the flexibility of content display is also improved.

In a possible implementation, the displaying the third number of cards includes: for each card among the third number of cards, displaying preview content of the second content corresponding to the card; or for each card among the third number of cards, displaying a blind box effect corresponding to the card.

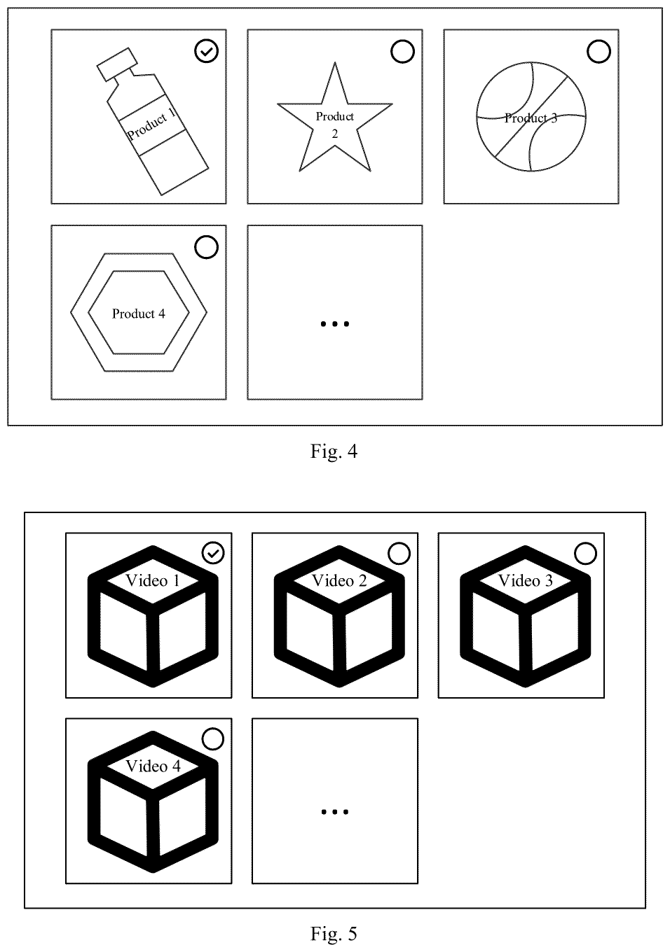

Exemplarily, continuing to take the case that the second content is the product introduction video as an example, referring to FIG. 4, for example, in response to the second content being the introduction video for product 1, the preview content of product 1, such as the brand logo, the appearance of product 1, or a certain video frame in the introduction video, etc., may be displayed in the card, which may be specifically set as required, and is not limited in the present disclosure. By displaying the preview content of the corresponding second content in the card, it is convenient for the user to select the content he/she is interested in to display, and the flexibility of content display is improved.

Exemplarily, referring to FIG. 5, the card may also be displayed in the form of a blind box, that is, the preview content of the second content corresponding to the card is not displayed. That is, the user selects a corresponding card when the second content corresponding to the card is unknown, and then the second content corresponding to the card is displayed, thereby improving the flexibility and interestingness of content display.

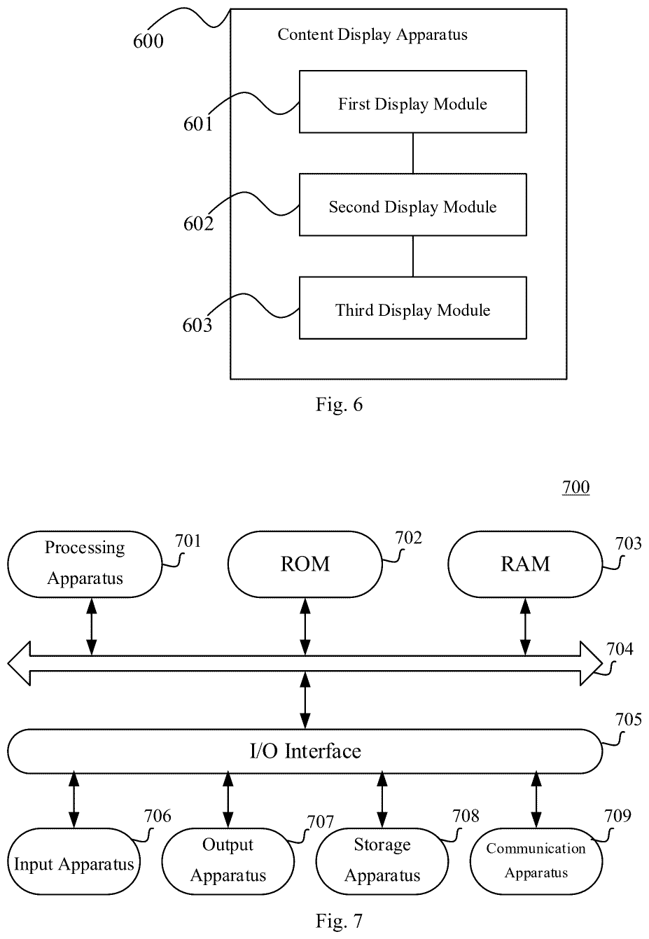

Based on the same concept, the embodiments of the present disclosure further provide a content display apparatus. As shown in FIG. 6, the content display apparatus 600 may include:
a first display module 601, configured to display a first content display page in response to a trigger operation for target content, where the first content display page is configured to display the target content, and the target content includes a first number of discontinuous pieces of first content;
a second display module 602, configured to display a first interactive control on the first content display page, and to sequentially display a second number of pieces of second content in response to a trigger operation for the first interactive control, where the second number is less than or equal to the first number, and the first content and the second content are the same type of content; and
a third display module 603, configured to, after all of the second number of pieces of second content are displayed, display, on the first content display page, target content that does not include the first number of pieces of first content.

With the above apparatus, before the target content is displayed, the second number of pieces of second content are sequentially displayed in response to the trigger operation for the first interactive control, and then during the display process of the target content, the target content including the first number of pieces of first content is not displayed. In this way, the display process of the target content can be prevented from being interrupted, the display smoothness of the target content can be improved, and the user experience can be improved. In addition, in the case where the second number is less than the first number, the total display duration of the second content is less than the total display duration of the first content, which can further improve the user experience.

Optionally, the second display module 602 includes:
a first display sub-module, configured to display a third number of cards in response to the trigger operation for the first interactive control, where each card corresponds to one piece of second content, and the third number is greater than the second number; and
a second display sub-module, configured to sequentially display the second number of pieces of second content corresponding to the second number of cards in response to a selection operation for the second number of cards among the third number of cards.

Optionally, the first display sub-module is configured to:
for each card among the third number of cards, display preview content of the second content corresponding to the card; or
for each card among the third number of cards, display a blind box effect corresponding to the card.

Optionally, the third display module 603 is configured to:
display a second interactive control after all of the second number of pieces of second content are displayed; and
display, on the first content display page, the target content that does not include the first number of pieces of first content in response to a trigger operation for the second interactive control.

Optionally, the content display apparatus 600 further includes a fourth display module, and the fourth display module is configured to:
display a third interactive control on the first content display page; and
display, on the first content display page, target content that includes the first number of pieces of first content in response to a trigger operation for the third interactive control.

Optionally, the content display apparatus 600 further includes:
a prompt module, configured to display prompt information on the first content display page, where the prompt information is used to prompt that the first number of pieces of first content are not displayed during a display process of the target content by displaying the second number of pieces of second content.

Optionally, the content display apparatus 600 further includes:
a fifth display module, configured to, before all of the second number of pieces of second content are displayed, redisplay the first interactive control on the first content display page in response to an interruption display operation for the second number of pieces of second content.

Optionally, the second display module 602 is configured to:
display a second content display page in response to the trigger operation for the first interactive control, where the first content display page is different from the second content display page; and
sequentially display the second number of pieces of second content on the second content display page.

Optionally, the target content, the first content and the second content are video content.

Based on the same concept, the embodiments of the present disclosure further provide a computer-readable medium having a computer program stored thereon, where when the computer program is executed by a processing apparatus, any one of the above content display methods is implemented.

Based on the same concept, the embodiments of the present disclosure further provide an electronic device, which may include:
a storage apparatus having a computer program stored thereon; and
a processing apparatus, configured to execute the computer program in the storage apparatus, to implement any one of the above content display methods.

Based on the same concept, the embodiments of the present disclosure further provide a computer program product, including a computer program, where when the computer program is executed by a processor, any one of the above content display methods is implemented.

Reference is made to FIG. 7 below, which illustrates a schematic structural diagram of an electronic device 700 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), a vehicle-mounted terminal (e.g., a vehicle-mounted navigation terminal), etc., and fixed terminals such as a digital TV, a desktop computer, etc. The electronic device shown in FIG. 7 is only an example, and should not bring any limitation to the functions and the scope of use of the embodiments of the present disclosure.

As shown in FIG. 7, the electronic device 700 may include a processing apparatus 701 (such as a central processing unit, a graphics processing unit, etc.) that may perform a variety of appropriate actions and processing in accordance with a program stored in a read-only memory (ROM) 702 or a program loaded from a storage apparatus 708 into a random-access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, a gyroscope, etc.; an output apparatus 707 including, for example, a liquid crystal display (LCD), a speaker, a vibrator, etc.; the storage apparatus 708 including, for example, a magnetic tape, a hard disk, etc.; and a communication apparatus 709. The communication apparatus 709 may allow the electronic device 700 to communicate wirelessly or by wire with other devices to exchange data. Although FIG. 7 shows the electronic device 700 having various apparatuses, it should be understood that it is not required to implement or have all of the illustrated apparatuses. More or fewer apparatuses may alternatively be implemented or provided.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, and the computer program includes program code for executing the method shown in the flowchart. In such an embodiment, the computer program may be downloaded and installed from the network through the communication apparatus 709, or installed from the storage apparatus 708, or installed from the ROM 702. When the computer program is executed by the processing apparatus 701, the above-mentioned functions defined in the methods of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, in which a computer-readable program code is carried. This propagated data signal may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by or in combination with an instruction execution system, apparatus, or device. The program code contained on the computer-readable medium may be transmitted by any suitable medium, including but not limited to: an electric wire, an optical cable, RF (radio frequency), etc., or any suitable combination thereof.

In some implementations, communication may be performed using any currently known or future-developed network protocol such as HTTP (HyperText Transfer Protocol), and may be interconnected with digital data communication (for example, a communication network) in any form or medium. Examples of the communication network include a local area network (“LAN”), a wide area network (“WAN”), an internet (for example, the Internet), and a peer-to-peer network (for example, an ad hoc peer-to-peer network), as well as any currently known or future-developed network.

The above computer-readable medium may be included in the above electronic device; or it may exist alone without being assembled into the electronic device.

The above computer-readable medium carries one or more programs. When the one or more programs are executed by the electronic device, the electronic device is caused to: display a first content display page in response to a trigger operation for target content, where the first content display page is configured to display the target content, and the target content includes a first number of discontinuous pieces of first content; display a first interactive control on the first content display page, and sequentially display a second number of pieces of second content in response to a trigger operation for the first interactive control, where the second number is less than or equal to the first number, and the first content and the second content are the same type of content; and after all of the second number of pieces of second content are displayed, display, on the first content display page, target content that does not include the first number of pieces of first content.

The computer program codes for performing the operations of the present disclosure may be written in one or more programming languages or a combination thereof. The above programming languages include object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the blocks may sometimes be executed in the reverse order, depending upon the functionality involved. It should also be noted that, each block of the block diagrams and/or flowcharts, and combinations of blocks in the block diagrams and/or flowcharts, may be implemented by special purpose hardware-based systems that perform the specified functions or operations, or may also be implemented by a combination of special purpose hardware and computer instructions.

The modules involved in the embodiments of the present disclosure may be implemented in software or hardware. The name of a module does not constitute the limitation on the module itself in some cases.

The functions described above herein may be performed, at least in part, by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include but is not limited to an electronic, magnetic, optical, electromagnetic, infrared, or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only a preferred embodiment of the present disclosure and an illustration of the applied technical principles. Those skilled in the art should understand that the scope of disclosure involved in the present disclosure is not limited to the technical solutions formed by the specific combination of the above technical features, but also covers other technical solutions formed by arbitrary combination of the above technical features or their equivalent features without departing from the above disclosed concept. For example, a technical solution formed by replacing the above features with technical features having similar functions disclosed in the present disclosure (but not limited to).

In addition, although the operations are described in a specific order, this should not be construed as requiring that the operations should be performed in the specific order shown or in a sequential order. Under certain circumstances, multitasking and parallel processing may be advantageous. Similarly, although several specific implementation details are included in the above discussion, these should not be construed as limitations on the scope of the present disclosure. Certain features described in the context of separate embodiments may also be implemented in combination in a single embodiment. Conversely, various features described in the context of a single embodiment may also be implemented in a plurality of embodiments separately or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are only exemplary forms for implementing the claims. Regarding the apparatus in the above embodiment, the specific manner in which each module performs the operation has been described in detail in the embodiment related to the method, and will not be described in detail here.

1. A content display method, comprising:
displaying a first content display page in response to a trigger operation for target content, wherein the first content display page is configured to display the target content, and the target content comprises a first number of discontinuous pieces of first content;
displaying a first interactive control on the first content display page, and sequentially displaying a second number of pieces of second content in response to a trigger operation for the first interactive control, wherein the second number is less than or equal to the first number, and the first content and the second content are a same type of content; and
after all of the second number of pieces of second content are displayed, displaying, on the first content display page, target content that does not comprise the first number of pieces of first content.

2. The content display method according to claim 1, wherein the sequentially displaying the second number of pieces of second content in response to the trigger operation for the first interactive control comprises:
displaying a third number of cards in response to the trigger operation for the first interactive control, wherein each card corresponds to one piece of second content, and the third number is greater than the second number; and
sequentially displaying the second number of pieces of second content corresponding to the second number of cards in response to a selection operation for the second number of cards among the third number of cards.

3. The content display method according to claim 2, wherein the displaying the third number of cards comprises:
for each card among the third number of cards, displaying preview content of the second content corresponding to the card; or
for each card among the third number of cards, displaying a blind box effect corresponding to the card.

4. The content display method according to claim 1, wherein after all the second number of pieces of second content are displayed, the displaying, on the first content display page, target content that does not comprise the first number of pieces of first content comprises:
displaying a second interactive control after all of the second number of pieces of second content are displayed; and
displaying, on the first content display page, the target content that does not comprise the first number of pieces of first content in response to a trigger operation for the second interactive control.

5. The content display method according to claim 1, further comprising:
displaying a third interactive control on the first content display page; and
displaying, on the first content display page, target content that comprises the first number of pieces of first content in response to a trigger operation for the third interactive control.

6. The content display method according to claim 2, further comprising:
displaying a third interactive control on the first content display page; and
displaying, on the first content display page, target content that comprises the first number of pieces of first content in response to a trigger operation for the third interactive control.

7. The content display method according to claim 3, further comprising:
displaying a third interactive control on the first content display page; and
displaying, on the first content display page, target content that comprises the first number of pieces of first content in response to a trigger operation for the third interactive control.

8. The content display method according to claim 4, further comprising:
displaying a third interactive control on the first content display page; and
displaying, on the first content display page, target content that comprises the first number of pieces of first content in response to a trigger operation for the third interactive control.

9. The content display method according to claim 1, further comprising:
displaying prompt information on the first content display page, wherein the prompt information is used to prompt that the first number of pieces of first content are not displayed during a display process of the target content by displaying the second number of pieces of second content.

10. The content display method according to claim 2, further comprising:
displaying prompt information on the first content display page, wherein the prompt information is used to prompt that the first number of pieces of first content are not displayed during a display process of the target content by displaying the second number of pieces of second content.

11. The content display method according to claim 3, further comprising:
displaying prompt information on the first content display page, wherein the prompt information is used to prompt that the first number of pieces of first content are not displayed during a display process of the target content by displaying the second number of pieces of second content.

12. The content display method according to claim 4, further comprising:
displaying prompt information on the first content display page, wherein the prompt information is used to prompt that the first number of pieces of first content are not displayed during a display process of the target content by displaying the second number of pieces of second content.

13. The content display method according to claim 5, further comprising:
displaying prompt information on the first content display page, wherein the prompt information is used to prompt that the first number of pieces of first content are not displayed during a display process of the target content by displaying the second number of pieces of second content.

14. The content display method according to claim 1, further comprising:
before all of the second number of pieces of second content are displayed, redisplaying the first interactive control on the first content display page in response to an interruption display operation for the second number of pieces of second content.

15. The content display method according to claim 2, further comprising:
before all of the second number of pieces of second content are displayed, redisplaying the first interactive control on the first content display page in response to an interruption display operation for the second number of pieces of second content.

16. The content display method according to claim 3, further comprising:
before all of the second number of pieces of second content are displayed, redisplaying the first interactive control on the first content display page in response to an interruption display operation for the second number of pieces of second content.

17. The content display method according to claim 1, wherein the sequentially displaying the second number of pieces of second content in response to the trigger operation for the first interactive control comprises:
displaying a second content display page in response to the trigger operation for the first interactive control, wherein the first content display page is different from the second content display page; and
sequentially displaying the second number of pieces of second content on the second content display page.

18. The content display method according to claim 1, wherein the target content, the first content and the second content are video content.

19. A non-transitory computer-readable storage medium, storing a computer program, wherein when the computer program is executed by a processor, a content display method is implemented, and the content display method comprises:
displaying a first content display page in response to a trigger operation for target content, wherein the first content display page is configured to display the target content, and the target content comprises a first number of discontinuous pieces of first content;
displaying a first interactive control on the first content display page, and sequentially displaying a second number of pieces of second content in response to a trigger operation for the first interactive control, wherein the second number is less than or equal to the first number, and the first content and the second content are a same type of content; and
after all of the second number of pieces of second content are displayed, displaying, on the first content display page, target content that does not comprise the first number of pieces of first content.

20. An electronic device, comprising:
at least one memory, configured to store a computer program; and
at least one processor, configured to execute the computer program stored in the memory, to implement a content display method, and the content display method comprises:
displaying a first content display page in response to a trigger operation for target content, wherein the first content display page is configured to display the target content, and the target content comprises a first number of discontinuous pieces of first content;
displaying a first interactive control on the first content display page, and sequentially displaying a second number of pieces of second content in response to a trigger operation for the first interactive control, wherein the second number is less than or equal to the first number, and the first content and the second content are a same type of content; and
after all of the second number of pieces of second content are displayed, displaying, on the first content display page, target content that does not comprise the first number of pieces of first content.
